(19) United States
(12) Patent Application Publication
(10) Pub. No.: US 2026/0124107 A1
(43) Pub. Date: May 7, 2026

(54) Massage Head Assembly and a Fascia Gun

(71) Applicant: ZHEJIANG AERLANG TECHNOLOGY CO.,LTD., Jinhua (CN)

(72) Inventor: Chuanmei ZANG, Jinhua (CN)

(73) Assignee: ZHEJIANG AERLANG TECHNOLOGY CO.,LTD., Jinhua (CN)

(21) Appl. No.: 19/437,180

(22) Filed: Dec. 30, 2025

Related U.S. Application Data
(63) Continuation of application No. PCT/CN2024/102547, filed on Jun. 28, 2024.

(30) Foreign Application Priority Data
Mar. 15, 2024 (CN) 202410300611.1
Mar. 15, 2024 (CN) 202420516211.X

(51) Int. Cl. A61H 23/02

(52) U.S. Cl. CPC A61H 23/02; A61H 2201/0153; A61H 2201/14

(57) ABSTRACT

The present invention relates to a massage head assembly and a fascia gun. The massage head assembly includes a massage head, a first and second connecting portion, and a piston connected to a driving mechanism inside the fascia gun. The second connecting portion is provided with a connecting hole for the first connecting portion to enter. The first connecting portion is provided with a first thread, and the connecting hole is provided with a second thread that cooperates with the first thread. The massage head and the piston are detachably connected by the rotational connection of the second thread and the first thread. The fascia gun includes a main body and the massage head assembly. In the present invention, the connection between the massage head and the piston has good stability, and the massage head will not shake after long-term use, yielding an improved user experience.

### TECHNICAL FIELD

The present invention relates to the technical field of fascia guns, and more particularly to a massage head assembly for a fascia gun, and a fascia gun.

### BACKGROUND

A fascia gun makes close contact with human muscles through the massage head at the front end. During use, it can effectively relieve muscle fatigue, promote blood circulation, and accelerate lactic acid metabolism. With the popularization of fascia guns, users have increasingly high requirements for their user experience. However, a common problem with the massage heads of fascia guns on the market is that the connection of the massage head is prone to shaking after prolonged use, resulting in an unstable connection. This shaking not only affects the stability of the massage head, but may also cause discomfort to the user during use, and may even damage the fascia gun due to long-term use.

### SUMMARY

The present invention provides a massage head assembly and a fascia gun, wherein the connection between the massage head and the piston has good stability, the massage head does not shake after long-term use, and the user experience is better.

In order to achieve the above object, the present invention adopts the following technical solutions:

A massage head assembly, applied in a fascia gun, including a massage head, a connecting portion, and a piston connected to a driving mechanism in the fascia gun.

The connecting portion includes a first connecting portion and a second connecting portion, the second connecting portion is provided with a connecting hole for the first connecting portion to enter, one of the first connecting portion and the second connecting portion is fixed to the massage head, and the other is fixed to the piston, the first connecting portion is provided with a first thread, and the connecting hole is provided with a second thread matching the first thread, so that the massage head and the piston are detachably connected by the second thread and the first thread rotating connection.

Preferably, the massage head assembly further includes a limiting member, the limiting member including an elastic fixing portion;

The elastic fixing portion is arranged between the first connecting portion and the connecting hole, so that the first connecting portion is in interference fit with the connecting hole and/or the second thread.

Preferably, the first connecting portion includes a connecting column and a boss and the first thread is arranged on the connecting column;

When the massage head is connected to the piston, the connecting column is located in the connecting hole, and the boss is located outside the connecting hole and abuts against the end of the second connecting portion.

Preferably, the limiting member further includes an elastic abutting portion, wherein the elastic abutting portion is connected to the end of the elastic fixing portion, the two are coaxial, and the elastic abutting portion is sleeved on the outer peripheral side of the first connecting portion to fill the gap between the boss and the second connecting portion.

Preferably, the first connecting portion is provided with a limiting groove in the circumferential direction, the elastic fixing portion is sleeved in the limiting groove, and the outer diameter of the elastic fixing portion is not less than the minor diameter of the second thread; or

In an embodiment, the elastic fixing portion is embedded in the connecting hole, and the inner diameter of the elastic fixing portion is not greater than the major diameter of the first thread.

Preferably, the driving mechanism in the fascia gun includes a connecting rod, and in the case where the first connecting portion is arranged on the massage head and the second connecting portion is arranged on the piston, one end of the connecting rod facing the piston is provided with a first mounting groove, the connecting hole extends through the piston, the end of the piston away from the massage head is provided with a blocking plate, the blocking plate is used to close the connecting hole, and the end of the piston away from the massage head is installed in the first mounting groove;

In an embodiment, the bottom of the blocking plate has a first vent hole, the first mounting groove is provided with a second vent hole, and the connecting hole communicates with the outside through the first vent hole and the second vent hole.

Preferably, the second thread is provided with a limiting protrusion on the end away from the first connecting portion, and when the first connecting portion and the second connecting portion are installed, the first thread and the limiting protrusion abut against each other with interference.

Preferably, the first thread is set as a protrusion, the connecting hole is also provided with a circular arc groove, the circular arc groove communicates with the second thread, the circular arc groove is provided with a limiting protrusion, and when the first connecting portion and the second connecting portion are installed, the protrusion and the limiting protrusion abut against each other with interference or the protrusion is restricted between the limiting protrusion and the side wall of the circular arc groove.

An embodiment includes a fascia gun, including a main body and the above-mentioned massage head assembly, wherein the main body includes a main housing, a battery, a motor and a driving assembly, the battery and the motor are arranged in the main housing and are electrically connected, and the output shaft of the motor is connected to the end of the connecting rod in the massage head assembly away from the massage head through the driving assembly.

Preferably, the main housing includes a head cover, an upper housing, a lower housing, a tail cover and a handle housing, the lower housing is arranged above the handle housing, the upper housing and the lower housing are connected to form a main cavity, the front end and the tail end of the main cavity are provided with through holes, the head cover is connected to the through hole at the front end of the main cavity, and the tail cover is arranged at the through hole at the rear end of the main cavity; the upper housing is convexly shaped above the motor to form a hump, the hump includes a front slope and a rear slope, and the projection line of the front slope along the transverse axis of the main cavity is sequentially provided with a plurality of transverse heat dissipation holes for heat dissipation, and the rear slope is provided with a plurality of longitudinal heat dissipation holes for heat dissipation in the direction of the projection line on the rear slope perpendicular to the transverse axis of the main cavity.

Compared with the prior art, the beneficial effects of the present invention are:
1. The first connecting portion and the second connecting portion of the massage head rotate relative to each other and are connected through the first thread and the first thread to realize the connection between the massage head and the piston, which plays the role of threaded connection, and can greatly play the role of circumferential and axial limiting. Compared with the direct interference fit connection, the threaded connection method is more stable and easier to install and disassemble.
2. By setting the elastic fixing portion, when the massage head and the piston are connected, the elastic fixing portion is arranged between the outer side wall of the first connecting portion and the connecting hole, so that the connecting portion is in interference fit with the connecting hole, which can play the role of anti-skid, shock absorption, sealing and easy disassembly, and the elastic fixing portion is arranged in the circumferential direction, which can greatly avoid the situation that the connection is prone to wear or even bending during use, and prolong the service life of the connecting portion and the piston.

### BRIEF DESCRIPTION OF THE DRAWINGS

In order to more clearly illustrate the specific embodiments of the present invention or the technical solutions in the prior art, the accompanying drawings to be used in the description of the specific embodiments or the prior art will be briefly introduced below. Obviously, the accompanying drawings in the following description are some embodiments of the present invention. For those of ordinary skill in the art, other accompanying drawings can also be obtained according to these accompanying drawings without creative effort.

FIG. 1 is an overall exploded view of Embodiment 1 of the massage head assembly in the present invention;

FIG. 2 is a schematic diagram of a blocking plate in Embodiment 1 of the massage head assembly in the present invention;

FIG. 3 is a schematic diagram of a mounting post in Embodiment 1 of the massage head assembly in the present invention;

FIG. 4 is a schematic diagram of a connecting portion in Embodiment 2 of the massage head assembly in the present invention;

FIG. 5 is a first overall schematic diagram of Embodiment 4 of the massage head assembly in the present invention;

FIG. 6 is a second overall schematic diagram of Embodiment 4 of the massage head assembly in the present invention;

FIG. 7 is a third overall schematic diagram of Embodiment 4 of the massage head assembly in the present invention;

FIG. 8 is a first overall schematic diagram of Embodiment 5 of the massage head assembly in the present invention;

FIG. 9 is a second overall schematic diagram of Embodiment 5 of the massage head assembly in the present invention;

FIG. 10 is an overall schematic diagram of Embodiment 6 of the massage head assembly in the present invention;

FIG. 11 is a schematic diagram of a connection hole in Embodiment 6 of the massage head assembly in the present invention;

FIG. 12 is an overall schematic diagram of Embodiment 7 of the massage head assembly in the present invention;

FIG. 13 is a schematic diagram of a connection hole in Embodiment 7 of the massage head assembly in the present invention;

FIG. 14 is a schematic diagram of a triangular prism structure of the first connecting post, the limiting groove, the elastic fixing portion, and the connecting hole in Embodiment 8 of the massage head assembly in the present invention;

FIG. 15 is a schematic diagram of a square prism structure of the first connecting post, the limiting groove, the elastic fixing portion, and the connecting hole in Embodiment 8 of the massage head assembly in the present invention;

FIG. 16 is a schematic diagram of a cross prism structure of the first connecting post, the limiting groove, the elastic fixing portion, and the connecting hole in Embodiment 8 of the massage head assembly in the present invention;

FIG. 17 is a schematic diagram of the cross prism in FIG. 16 of the embodiment of the present invention;

FIG. 18 is a first overall schematic diagram of the fascia gun in the present invention;

FIG. 19 is a second overall schematic diagram of the fascia gun in the present invention;

FIG. 20 is an overall cross-sectional view of the fascia gun in the present invention;

FIG. 21 is an overall schematic diagram of the fascia gun in the present invention (excluding the upper cover);

FIG. 22 is a first schematic diagram of the inner head cover of the fascia gun in the present invention;

FIG. 23 is a second schematic diagram of the inner head cover of the fascia gun in the present invention;

FIG. 24 is a schematic diagram of the cooperation between the head cover and the piston in the present invention;

FIG. 25 is a schematic diagram of the inner upper shell of the fascia gun in the present invention;

FIG. 26 is a top view of the inner upper shell of the fascia gun in the present invention;

FIG. 27 is a diagram of the size and position of the hump on the upper shell in the present invention;

FIG. 28 is a first schematic diagram of the inner lower shell of the fascia gun in the present invention;

FIG. 29 is an enlarged schematic diagram of A in FIG. 28 of the present invention;

FIG. 30 is a second schematic diagram of the inner lower shell of the fascia gun in the present invention;

FIG. 31 is an enlarged schematic diagram of B in FIG. 30 of the present invention;

FIG. 32 is a schematic diagram of the shock absorber in the present invention;

FIG. 33 is a bottom view of the handle shell and the battery in the present invention;

FIG. 34 is a top view of the handle shell and the battery in the present invention.

### DESCRIPTION OF REFERENCE NUMERALS

1, Massage head; 1001, Striking part; 2, Connecting portion; 201, Boss; 202, First connecting post; 203, Second connecting post; 204, Connecting hole; 205, Elastic fixing portion; 206, Elastic abutting portion; 207, Limiting groove; 208, Arc-shaped groove; 3, Piston; 4, First helix; 5, Second helix; 6, Blocking plate; 61, First vent hole; 62, Positioning post; 7, Connecting rod; 8, Mounting post; 81, First mounting groove; 82, Positioning hole; 83, Second vent hole; 9, First internal thread; 10, First external thread; 11, Bump; 12, Helical groove; 13, Limiting protrusion; 14, Limiting plate; 15, Shock absorption structure; 151, Hard ball; 152, Soft buffer portion; 16, Fixing ring; 17, Upper shell; 171, Limiting post; 172, Upper connecting post; 173, Sealing edge; 174, Display structure mounting groove; 175, Upper baffle; 18, Lower shell; 181, Head cover connecting ring; 182, Annular mounting groove; 183, Head cover connecting hole; 184, Upper cover limiting groove; 185, Second mounting groove; 186, Lower connecting post; 1861, Mounting wall; 1862, Connecting groove; 1863, Lower connecting hole; 187, Sealing groove; 188, Lower baffle; 19, Head cover; 191, Third connecting post; 192, Annular groove; 193, Annular boss; 194, Reinforcing plate; 195, Wear-resistant ring; 196, Fourth connecting post; 197, Fastener; 20, Hump; 2001, Transverse heat dissipation hole; 2002, Longitudinal heat dissipation hole; 2003, Semi-annular groove; 21, Handle shell; 2111, Fixing plate; 2112, Battery supporting base; 2113, Charging board mounting post; 22, Battery; 23, Motor; 24, Motor fixing plate; 2411, Drive groove; 25, Insulating sleeve; 26, Shock absorber; 2611, Relief groove; 2612, Receiving groove; 2613, Wire groove; 27, Eccentric wheel; 28, Bearing; 29, Annular convex edge; 30, Display control board; 31, Tail cover; 32, Display panel; 33, Arc-shaped structure; 34, Bottom cover structure; 3411, Charging cover; 3412, Charging board.

### DETAILED DESCRIPTION OF EMBODIMENTS

The technical solutions of the present invention will be clearly and completely described below in conjunction with the accompanying drawings. Obviously, the described embodiments are some, but not all, of the embodiments of the present invention. All other embodiments obtained by those of ordinary skill in the art based on the embodiments of the present invention without creative effort shall fall within the protection scope of the present invention.

It should be noted that, in the description of the present invention, the terms “center”, “up”, “down”, “left”, “right”, “vertical”, “horizontal”, “inner”, “outer”, etc., indicate the orientation or positional relationship based on the orientation or positional relationship shown in the drawings, and are only for the convenience of describing the present invention and simplifying the description, and do not indicate or imply that the device or component referred to must have a specific orientation, be constructed and operated in a specific orientation, and therefore cannot be understood as a limitation of the present invention. In addition, the terms “first”, “second”, and “third” are used for descriptive purposes only and cannot be understood as indicating or implying relative importance.

It should be noted that, in the description of the present invention, unless otherwise explicitly specified and limited, the terms “installation”, “connection”, and “connected” should be understood broadly, for example, it can be a fixed connection, a detachable connection, or an integral connection; it can be a mechanical connection or an electrical connection; it can be directly connected or indirectly connected through an intermediate medium, or it can be a communication inside two components. For those of ordinary skill in the art, the specific meaning of the above terms in the present invention can be understood in specific situations.

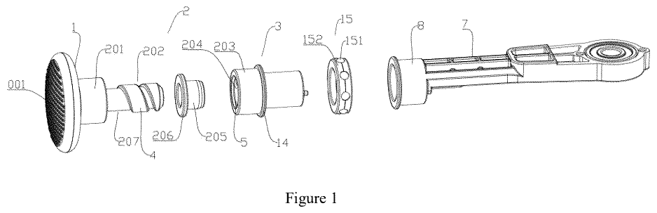

The present invention provides a massage head assembly applied to a fascia gun, as shown in FIG. 1, specifically including a massage head 1, a connection coupling 2, and a piston 3. A connecting rod 7 is also arranged in the fascia gun, and the piston 3 is connected to the connecting rod 7; wherein the massage head 1 has a striking part 1001, wherein the striking part 1001 is used for muscle massage, physiotherapy and other purposes, wherein the shape of the striking part 1001 includes but is not limited to a cylindrical structure, a prismatic structure, a spherical structure, a wave structure, a flat plate structure, or a combination of the above structures. The piston 3 is connected to one end of the connecting rod 7, and the other end of the connecting rod 7 is connected to the driving end of the driving assembly in the fascia gun. The connection coupling 2 is used to connect the piston 3 and the massage head 1, so that the driving assembly in the fascia gun can drive the connecting rod 7, the connecting rod 7 will drive the piston 3 to reciprocate linearly, and the piston 3 drives the massage head 1 to reciprocate through the connection coupling 2 to realize massage.

One problem that commonly exists in the fascia gun massage heads in the existing massage head assembly is that the connection between the massage head 1 and the piston 3 is prone to shaking after long-term use, resulting in unstable connection. This shaking not only affects the stability of the massage head 1, but may also cause discomfort to the user during use, and may even damage the fascia gun due to long-term use. In this embodiment, the connection coupling 2 in the massage head assembly is used to connect the massage head 1 and the piston 3. The connection coupling 2 specifically includes a first connection part and a second connection part. One of the first connection part and the second connection part is connected to the massage head 1, and the other is connected to the piston 3. It should be noted that the connection here can be separate and then fixed by a structure or directly integrated. The first connection part has a first thread 4, and the second connection part is provided with a connection hole 204 for the first connection part to enter. The connection hole 204 has a second thread 5 that cooperates with the first thread 4. The first connection part is inserted into the connection hole 204 through the rotational connection of the first thread 4 and the second thread 5 to realize the detachable connection between the massage head 1 and the piston 3. It can be known that both the first thread 4 and the second thread 5 have corresponding matching protrusions and grooves. If both are continuous spiral structures, then the first thread 4 can be regarded as an external thread, and the second thread 5 can be regarded as an internal thread. The two are connected by rotation to realize the connection between the massage head 1 and the piston 3. Therefore, the specific structure of the first thread 4 and the specific structure of the second thread 5 can realize the rotational cooperation to realize the rotational connection between the massage head 1 and the piston 3. The first thread 4 and the second thread 5 are essentially equivalent to the thread connection of the internal thread and the external thread. On the one hand, the tightening path at the connection is longer and it is less likely to loosen. On the other hand, it makes the massage head 1 and the piston 3 easier to disassemble, which is convenient for maintenance and replacement.

Further, in order to make the connection between the piston 3 and the massage head 1 more stable, the connection coupling 2 also includes an elastic fixing part 205, wherein the elastic fixing part 205 is made of an elastic material and has elasticity, and can be compressed and stretched, specifically, it can be a rubber sleeve; when the piston 3 is connected to the massage head 1, the first connection part is located in the connection hole 204, and the first thread 4 is connected to the second thread 5 in cooperation. At this time, the elastic fixing part 205 is located between the first connection part and the connection hole 204, so that the first connection part and/or the second thread 5 are interference fit, specifically including the following situations: the first type: the elastic fixing part 205 is sleeved on the outer side wall of the first connection part except for the location of the first thread 4, the outer side wall of the elastic fixing part 205 abuts against the inner side wall of the connection hole 204 except for the location of the second thread 5, and the elastic fixing part 205 is compressed, so that the first connection part and the connection hole 204 are indirectly interference fit; the second type: the elastic fixing part 205 is sleeved on the outer side wall of the first connection part except for the location of the first thread 4, the outer side wall of the elastic fixing part 205 abuts against the protrusion of the second thread 5, and the elastic fixing part 205 is compressed, so that the first connection part and the connection hole 204 are indirectly interference fit; the third type: the elastic fixing part 205 is sleeved on the outer side wall of the first connection part except for the location of the first thread 4, one part of the elastic fixing part 205 abuts against the protrusion of the second thread 5, and the other part abuts against the inner side wall of the connection hole 204, and the elastic fixing part 205 is compressed, so that the first connection part and the connection hole 204 are indirectly interference fit; the fourth type: the elastic fixing part 205 is located on the inner side wall of the connection hole 204, the protrusion of the first thread 4 abuts against the inner side wall of the elastic fixing part 205, and the elastic fixing part 205 is compressed, so that the first connection part and the connection hole 204 are indirectly interference fit; in summary, the above four installation methods of the elastic fixing part 205 all make the first connection part and the connection hole 204 interference fit. On the one hand, the connection can be sealed to prevent moisture, dust and other impurities from entering. On the other hand, the friction force can be used to further enhance the connection stability, and it can play a role in damping in the axial or circumferential direction, effectively reducing the impact and vibration generated by the massage head 1 during operation. Moreover, the elastic fixing part 205 is circumferentially wrapped on the outer side wall of the first connection, which can avoid the force of the human body on the gun body to a certain extent, so that the connection is prone to bending, protecting the connection from damage, and extending the service life of the connection. Furthermore, the softness of the elastic fixing part 205 makes the elastic fixing part 205 easier to detach when the first connection part is disassembled, reducing friction and damage during disassembly.

The first connection part includes a first connection column 202 and a boss 201. The first thread 4 is arranged on the first connection column 202. The connection coupling 2 also includes an elastic abutting part 206. The elastic abutting part 206 is made of an elastic material and has elasticity, and can be compressed, specifically, it can be a rubber sleeve; when the massage head 1 is connected to the piston 3, the first connection column 202 enters the connection hole 204. At this time, the boss 201 is located outside the connection hole 204, and the elastic abutting part 206 is sleeved on the outside of the first connection column 202 and located between the boss 201 and the second connection part. The elastic abutting part 206 is compressed to fill the gap between the boss 201 and the second connection part, making the connection structure between the massage head 1 and the piston 3 more compact, limiting the massage head 1 in the axial and circumferential directions, and avoiding shaking. It should be noted that the elastic fixing part 205 and the elastic abutting part 206 can be separated and arranged at intervals, or they can be integrated. The structure shown in FIG. 1 is preferred.

In summary, the massage head 1 in the present invention is first connected through the first connection part and the second connection part, that is, the rotational connection of the first thread 4 and the second thread 5, which plays the role of thread connection, and the connection method is more stable. Then, by setting the elastic fixing part 205, the two are interference fit when the first connection part is installed in the connection hole 204, increasing the friction force and enhancing the connection stability, which can reduce the wear between the connection coupling 2 and the connection hole 204. Furthermore, the elastic abutting part 206 is set to fill the connection gap between the first connection part and the second connection part, making the connection structure more compact, limiting the massage head 1 in the axial and circumferential directions, and avoiding shaking. Therefore, the cooperation of the three makes the connection at the connection between the massage head 1 and the piston 3 more stable, increasing the service life of the massage head 1 and the user experience.

Specifically, the structure of the massage head assembly is as follows:

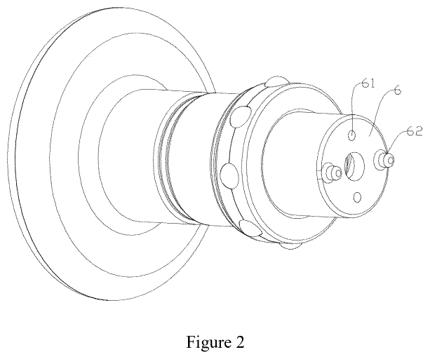

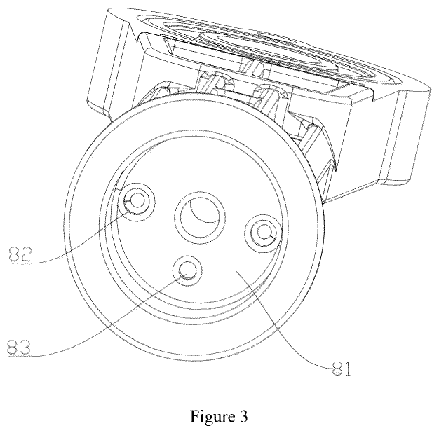

As shown in FIGS. 1-3, the massage head assembly in this embodiment specifically includes a massage head 1, a connection coupling 2, and a piston 3. A connecting rod 7 is also arranged in the fascia gun, and the piston 3 is connected to the connecting rod 7. The connection coupling 2 includes a first connection part and a second connection part. The first connection part includes a boss 201 and a first connection column 202. The boss 201 is integrally fixedly connected or detachably connected to the side wall of the massage head 1 away from the striking part. The first end of the first connection column 202 is fixedly or detachably connected to the side wall of the boss 201 away from the massage head 1. The above-mentioned detachable connection can be a bolt connection. The massage head 1, the boss 201, and the first connection column 202 are all arranged coaxially. The boss 201 has a certain thickness, and the outer diameter is greater than the diameter of the first connection column 202. The outer diameter of the end of the second connection part close to the massage head 1 can make the connection between the first connection column 202 and the massage head 1 more firm, and can also reduce the gap between the massage head 1 and the piston 3, enhance the stability, and be more beautiful. The outer peripheral side of the first connection column 202 has a first thread 4. The first thread 4 has a certain length in the axial direction, and preferably forms more than one turn of the first thread. The second connection part includes a second connection column 203. The second connection column 203 is connected to the piston 3. The side wall of the second connection column 203 close to the massage head 1 is recessed inward to form a connection hole 204 coaxial with the piston 3. The connection hole 204 has a second thread 5 that cooperates with the first thread 4. The second thread 5 has a certain length in the axial direction, and at least forms one turn of the second thread. Through the rotational cooperation of the first thread 4 and the second thread 5, the first connection column 202 is inserted into the connection hole 204 to realize the detachable connection between the first connection part and the second connection part; and the end of the first thread 4 preferably extends to the end of the connection hole 204 close to the massage head 1, and the end of the second thread 5 preferably extends to the end of the connection hole 204 close to the massage head 1, so that the shaking between the two can be reduced at the beginning of the connection, preventing damage to the thread and increasing the connection firmness. It should be noted that the positions of the first connection part and the second connection part in the above description of Embodiment 1 can also be exchanged, that is, the manner in which the boss 201 and the first connection column 202 are connected to the piston 3 and the second connection column 203 is connected to the massage head 3 is another implementation manner.

Preferably, in order to facilitate the insertion of the first connection column 202 into the connection hole 204, the second end of the first connection column 202 is provided with a rounded corner or a chamfer.

Both the first thread 4 and the second thread 5 have a certain length in the axial direction, and the geometry of the thread can adopt a trapezoidal thread. When the first thread 4 includes multiple turns of thread and the second thread 5 includes multiple turns of thread, then both the first thread 4 and the second thread 5 have corresponding protrusions and grooves. Preferably, the ratio of the width of the protrusions and grooves in the first thread 4 is between 2 times and 5 times. Correspondingly, the protrusions and grooves of the second thread 5 are correspondingly arranged to meet the rotational connection between the first thread 4 and the second thread 5. This setting method has the following advantages: 1. Improving the bearing capacity of the massage head assembly: the wide thread part can disperse the load, making the massage head assembly less likely to loosen or be damaged when subjected to large pressure or tension, improving the stability and bearing capacity of the massage head assembly; 2. Improving the anti-skid performance of the massage head assembly: the wide thread can increase the friction between the first thread and the second thread, preventing the massage head from loosening or falling off due to vibration and other reasons during movement, improving the anti-skid performance of the massage head assembly; 3. Convenient disassembly and assembly: the wide thread makes the massage head easier to align during disassembly and assembly, reducing the difficulty of operation and improving work efficiency; 4. Enhancing the aesthetics of the massage head assembly: the design of the wide thread can make the surface of the massage head assembly look more beautiful, improving the overall appearance quality of the product.

Correspondingly, the connecting portion 2 further includes a limiting member. The limiting member includes an elastic fixing portion 205 and an elastic abutting portion 206. The elastic fixing portion 205 and the elastic abutting portion 206 are coaxially arranged. The elastic abutting portion 206 is disposed at the end of the elastic fixing portion 205 and integrally formed with the elastic fixing portion 205. Correspondingly, a limiting groove 207 is provided circumferentially on the end of the first connecting post 202 near the boss 201. Both the elastic fixing portion 205 and the elastic abutting portion 206 are sleeve structures, which are sleeved on the outer peripheral side of the limiting groove 207 during installation, and can axially limit the elastic fixing portion 205 and the elastic abutting portion 206. Preferably, the axial length of the limiting member formed by the elastic fixing portion 205 and the elastic abutting portion 206 does not exceed and is close to the axial length of the limiting groove 207, and the length error between the two does not exceed 0.1 cm; specifically, the outer diameter of the elastic fixing portion 205 is not less than the minor diameter d1 of the concave groove of the second thread 5, and the outer diameter of the elastic abutting portion 206 is greater than the aperture of the connecting hole 204, preferably equal to the aperture, so that when the massage head 1 is connected to the piston 3, the first connecting post 202 is screwed into the connecting hole 204 through the rotational connection of the first thread 4 and the second thread 5. At this time, the elastic fixing portion 205 is located between the outer side wall of the limiting groove 207 and the second thread 5, and is squeezed by the protrusion of the second thread 5, filling the fitting gap between the protrusion of the second thread 5 and the limiting groove 207, so that the first connecting post 202 and the connecting hole 204 are indirectly in an interference fit, so that the connecting hole 204 forms a sealed space to prevent moisture, dust and other impurities from entering, and at the same time, the friction between the connecting hole 204 and the first connecting post 202 is significantly enhanced, and at this time, the elastic abutting portion 206 is located outside the connecting hole 204 and between the boss 201 and the second connecting post 203, and is squeezed. Preferably, the top of the elastic fixing portion 205 facing the connecting hole 204 can be appropriately designed as a chamfer or a rounded corner, and/or the opening of the connecting hole 204 is designed as a flared opening or provided with a chamfer or a rounded corner, so that the elastic fixing portion 205 can be easily inserted into the connecting hole 204.

In this embodiment, the first connecting portion is fixed to the massage head, and the second connecting portion is fixed to the piston. Correspondingly, the second connecting post 203 is integrally provided with the piston 3. The second connecting post 203 is located at one end of the piston 3 near the massage head 1, and the connecting hole 204 penetrates the entire piston 3. Specifically, both ends of the piston 3 have different diameters, forming a step. A circumferential ring-shaped limiting plate 14 is also formed at the step. The end of the piston 3 away from the massage head 1 is fitted with a shock-absorbing structure 15, which, when installed inside the fascia gun, can counteract the lateral swaying during the operation of the connecting rod. The connecting rod 7 is used to drive the piston 3. In this embodiment, the first end of the connecting rod 7 is connected to the drive assembly of the fascia gun, and the second end is provided with a mounting post 8. The mounting post 8 is provided with a first mounting groove 81 on the side wall near the massage head 1. In order to facilitate the installation of the end of the piston 3 away from the massage head 1 in the first mounting groove 81, a blocking plate 6 is provided at the end of the piston 3 away from the massage head 1. The blocking plate 6 is used to close the connection hole 204. When connecting, the end of the piston 3 away from the massage head 1 is installed in the first mounting groove 81. The blocking plate 6 is connected to the bottom of the first mounting groove 81 by bolts. In this configuration, the two side walls of the shock absorption structure 15 are respectively abutted by the limiting plate 14 and the side wall of the mounting post 8, and are clamped in the middle. The blocking plate 6 is provided with a first mounting hole, and the bottom of the corresponding first mounting groove 81 is provided with a corresponding threaded hole. The blocking plate 6 is connected to the bottom of the first mounting groove 81 by bolts. Of course, the threaded hole at the bottom of the first mounting groove 81 can also be a smooth hole. When using screws or bolts for fixing, the threads of the screws or bolts rotate on the surface of the hole to form threads.

Furthermore, when the first connecting post 202 is screwed into the connecting hole 204, the air inside the connecting hole 204 is compressed due to the sealing effect of the elastic fixing part 205, and the air pressure inside the connecting hole 204 will increase. In order to facilitate the smooth screwing of the first connecting post 202 into the connecting hole 204, a first vent hole 61 is provided at the bottom of the baffle plate 6. Correspondingly, a second vent hole 83 is provided at the bottom of the first mounting groove 81. The first vent hole 61 and the second vent hole are in the same position and preferably arranged opposite to each other along the length of the fascia gun. During the process of installing the piston 3 end into the first mounting groove 81, the air in the connecting hole 205 can be discharged through the first vent hole 61 and the second vent hole 83. After the piston 3 is installed, during the process of the first connecting post 202 being screwed into the connecting hole 204, the air in the connecting hole 204 can be discharged to the external environment through the first vent hole 61 and the second vent hole 83, which facilitates the screwing of the first connecting post 202 into the connecting hole 204. Of course, the first vent 61 can also be located on the wall of the connecting hole 204, as long as it connects to the outside. A corresponding second connecting hole 204 should also be provided to ensure that the second connecting hole 204 and the piston 3 can communicate after installation.

Preferably, at least one positioning post 62 is provided on the side wall of the baffle plate 6 away from the massage head 1. A corresponding number of positioning holes 82 are provided in the first mounting groove 81. During installation, the piston 3 is positioned by installing the positioning post 62 into the corresponding positioning hole 82. Furthermore, the positioning post 62 also has a circumferential limiting function, preventing the piston 3 from rotating circumferentially within the first mounting groove 81, thus making the installation of the piston 3 and the connecting rod 7 more stable.

Correspondingly, the shock-absorbing structure 15 specifically includes hard balls 151 and a soft buffer part 152. The soft buffer part 152 is sleeved on the piston 3, and the hard balls 151 are rolled and embedded in the soft buffer part 152 and partially protrude from the outer wall of the soft buffer part 152. The soft buffer part 152 is an elastic sleeve, which provides good shock absorption, is low in cost, and is readily available.

Specifically, the outer periphery of the elastic sleeve has a ball mounting groove for mounting the hard balls 151. The hard balls 151 are rolled and positioned within the ball mounting groove, and the area of the hard balls 151 protruding from the ball mounting groove is no greater than the area within the ball mounting groove, preventing the hard balls 151 from dislodging from the ball mounting groove. Specifically, the elastic sleeve has a split structure, including a first part and a second part. The first part has a first half-groove, and the second part has a second half-groove. The first and second half-grooves form a ball bearing mounting groove, facilitating the installation of the hard ball bearing 151. The first and second parts can be fixed together by adhesive bonding. Alternatively, in other embodiments, the elastic sleeve can be a one-piece structure, and the ball bearing mounting groove can be deformable. When the hard ball bearing 151 needs to be inserted into the ball bearing mounting groove, force is applied to enlarge the groove opening. After the hard ball bearing 151 is inserted, the groove opening automatically shrinks, thus confining the hard ball bearing 151 within the groove.

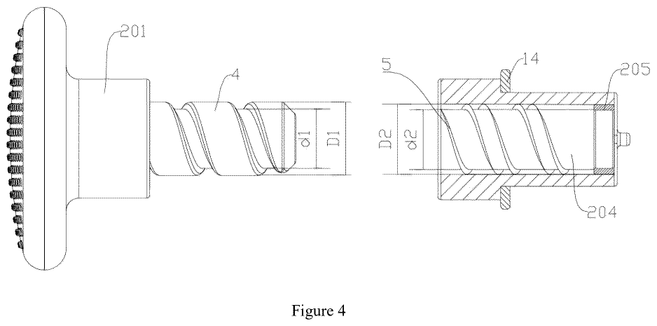

Embodiment 2: As shown in FIG. 4, the difference between this embodiment and Embodiment 1 is that the limiting member only includes the elastic fixing part 205. The inner diameter of the elastic fixing part 205 does not exceed the major diameter D2 of the inner protrusion of the first spiral 4. Correspondingly, in this embodiment, the connecting column does not have a limiting groove 207.

Specifically, in this embodiment, the elastic fixing part 205 is located at the end of the connecting hole 204 away from the massage head 1. When the first connecting post 202 is installed in the connecting hole 204, after the first spiral 4 and the second spiral 5 engage, the first spiral 4 at the end of the first connecting post 202 away from the massage head 1 will be inserted into the elastic fixing part 205, thereby compressing the elastic fixing part 205 and indirectly causing an interference fit between the end of the first connecting post 202 away from the massage head 1 and the end of the connecting hole 204 away from the massage head 1. The difference from Embodiment 1 is that in this embodiment, the elastic fixing part 205 causes an interference fit between the end of the first connecting post 202 away from the massage head 1 and the end of the connecting hole 204 away from the massage head 1, while in Embodiment 1, the elastic fixing part 205 causes an interference fit between the end of the first connecting post 202 away from the massage head 1 and the end of the connecting hole 204 near the massage head 1.

Example 3 The difference between this example and Example 1 is that the limiting member only includes the elastic abutment portion 206. After installation, the elastic abutment portion 206 is located between the boss 201 and the second connecting post 203, and the elastic abutment portion 206 is compressed, thereby reducing the shaking between the massage head 1 and the piston 3 to a certain extent.

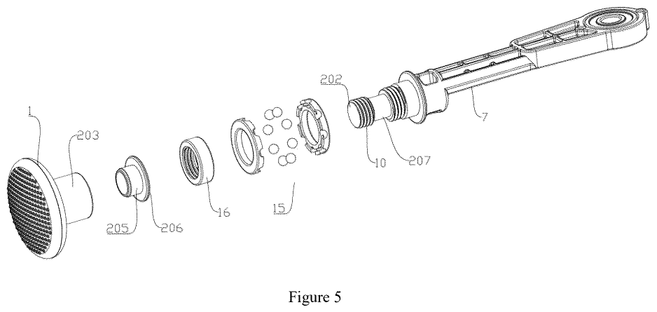

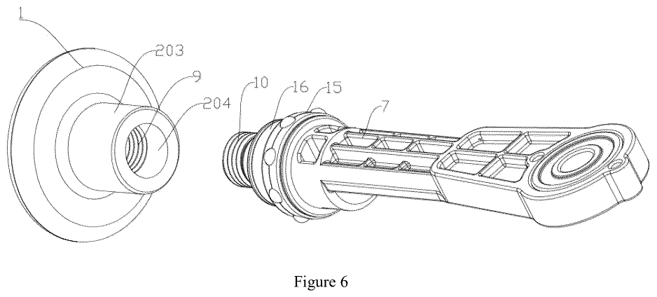

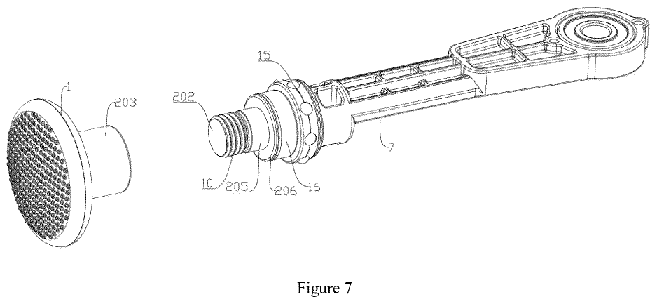

Example 4 As shown in FIGS. 5-7, the massage head assembly in this example specifically includes a massage head 1, a connecting part 2, and a piston 3. The piston 3 is connected to the connecting rod 7 in the drive mechanism inside the fascia gun. The connecting part 2 includes a first connecting part and a second connecting part. The first connecting part includes a first connecting post 202 and a boss. In this example, the first connecting post 202 is disposed at the end of the piston 3 near the massage head 1 and is integrally formed. A fixing ring 16 is threadedly connected to the outer wall of the piston 3. The outer diameter of the fixing ring 16 is larger than the outer diameter of the first connecting post 202. When threadedly connected to the outer wall of the piston 3, it is equivalent to the aforementioned boss. A first helix 4 is formed on the outer wall of the first connecting post 202. In this example, it is configured as a first external thread 10. The first external thread 10 extends to the end side wall of the first connecting post 202 near the massage head 1. The second connecting part includes a second connecting post 203, which is connected to the massage head 1. A connecting hole 204, coaxial with the second connecting post 203, is formed in the recessed sidewall away from the massage head 1. A second spiral 5, configured as a first internal thread 9 in this embodiment, is provided within the connecting hole 204. The first internal thread 9 does not extend to the end sidewall of the connecting hole 204 away from the massage head 1. The end of the connecting hole 204 away from the massage head 1 is a smooth hole with a diameter larger than the minor diameter of the first internal thread 9. The outer diameter of the elastic fixing part 205 is not smaller than the diameter of the smooth hole. When the massage head 1 is connected to the piston 3, only one end of the first connecting post 202 near the massage head 1 needs to be inserted into the connecting hole 204, connected by the first external thread 10 and the first internal thread 9. At this time, the fixing ring 16 abuts against the outer sidewall of the second connecting post 203, and the elastic fixing part 205 is located between the outer sidewall of the limiting groove 207 and the smooth hole, and is squeezed by the sidewall of the smooth hole, filling the fitting gap between the smooth hole and the limiting groove 207.

Furthermore, the connecting part 2 also includes a limiting member, which includes an elastic fixing part 205 and an elastic abutment part 206. The elastic fixing part 205 and the elastic abutment part 206 are coaxially arranged, and the elastic abutment part 206 is located at the end of the elastic fixing part 205 and the two are integrally formed. Correspondingly, the fixing ring 16 and the first external thread 10 are spaced apart, and a limiting groove 207 is provided on the outer wall of the piston 3 between the first external thread 10 and the fixing ring 16. During installation, the limiting member is sleeved on the outer periphery of the limiting groove 207, which can axially limit the elastic fixing part 205 and the elastic abutment part 206. Preferably, the axial length of the limiting member formed by the elastic fixing part 205 and the elastic abutment part 206 is equal to the axial length of the limiting groove 207, and the length error between the two does not exceed 0.1 cm. Specifically, the outer diameter of the elastic fixing part 205 is not less than the minor diameter of the first internal thread 9, and the outer diameter of the elastic abutment part 206 is the diameter of the connecting hole 204. Thus, when the massage head 1 and the piston 3 are connected, the elastic fixing part 205 is located between the outer wall of the limiting groove 207 and the first internal thread 9, and is squeezed by the first internal thread 9, filling the fitting gap between the first internal thread 9 and the limiting groove 207. This results in an indirect interference fit between the end of the piston 3 (the first connecting post 202) and the connecting hole 204, forming a sealed space in the connecting hole 204 to prevent moisture, dust, and other impurities from entering. At the same time, the friction at the connection point is significantly enhanced. Moreover, at this time, the elastic abutment part 206 is located outside the connecting hole 204 and between the fixing ring 16 and the second connecting post 203, and is squeezed. To facilitate the insertion of the first connecting post 202 into the connecting hole 204, the end of the first connecting post 202 near the massage head 1 is chamfered or rounded. The top of the elastic fixing part 205 facing the connecting hole 204 can be appropriately designed with a chamfer or rounded corner, and/or the opening of the connecting hole 204 can be flared or chamfered or rounded, making it easier for the elastic fixing part 205 to be inserted into the connecting hole 204.

In another embodiment, the first internal thread 9 extends to the end sidewall of the connecting hole 204 away from the massage head 1. The outer diameter of the elastic fixing part 205 is not less than the diameter of the aperture. Thus, when the massage head 1 and piston 3 are connected, the elastic fixing part 205 is located between the outer wall of the limiting groove 207 and the first internal thread 9, and is compressed, filling the mating gap between the first internal thread 9 and the limiting groove 207.

The connecting rod 7 has its first end connected to the drive assembly within the drive mechanism, and its second end equipped with a mounting post 8. The end of the piston 3 furthest from the massage head 1 is fixedly connected to the mounting post 8. A shock-absorbing structure 15 is fitted onto the outer wall of the piston 3. This shock-absorbing structure 15 is the same as that in Embodiment 1. When the connection is complete, the two side walls of the soft buffer portion 152 within the shock-absorbing structure 15 abut against the mounting post 8 and the fixing ring 16, respectively.

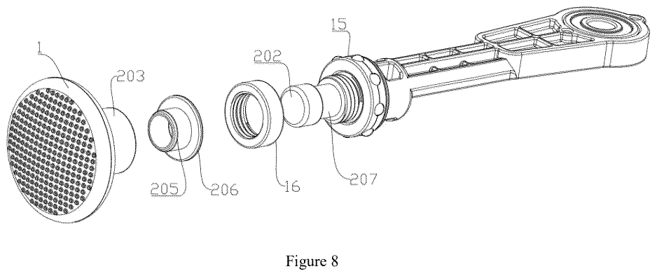

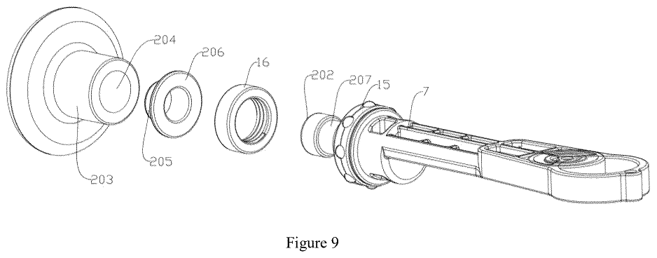

Embodiment 5, as shown in FIGS. 8-9, differs from Embodiment 4 in the following ways: the entire connecting hole 204 is a smooth hole; the end of the first connecting post 202 near the massage head 1 does not have a first external thread 10 and is a smooth post. When connecting the massage head 1 to the piston 3, simply insert the end of the piston 3 near the massage head 1 into the connecting hole 204. The elastic fixing part 205 within the corresponding limiting member will then be located between the side wall of the end of the connecting hole 204 away from the massage head 1 and the first connecting post 202. Since the major diameter of the elastic fixing part 205 is not greater than the diameter of the connecting hole 204, the elastic fixing part 205 is compressed and deformed, indirectly causing an interference fit between the piston 3 and the connecting hole 204. Compared to directly interfering with the piston 3, this makes installation and disassembly between the first connecting post 202 and the connecting hole 204 easier. At this time, the elastic abutment part 206 is located between the fixing ring 16 and the second connecting post 203, filling the gap between them and providing shock absorption and limiting. To facilitate the insertion of the first connecting post 202 into the connecting hole 204, the end of the piston 3 near the massage head 1 is provided with a chamfer or rounded corner.

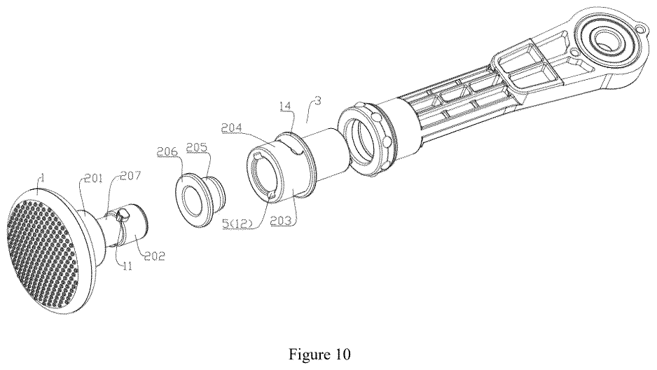

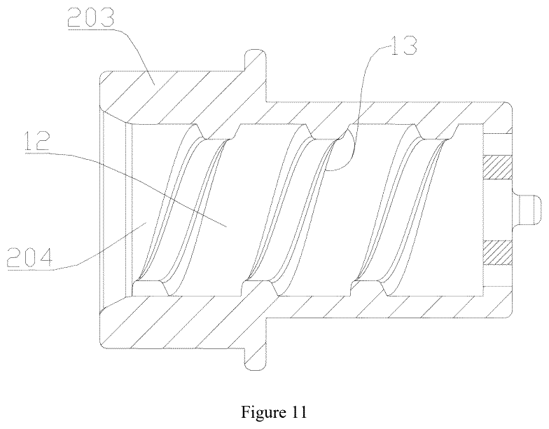

Example 6 As shown in FIGS. 10-11, the massage head assembly in this example specifically includes a massage head 1, a connecting part 2, and a piston 3. The piston 3 is connected to the connecting rod 7 in the drive mechanism inside the fascia gun. The connecting part 2 includes a first connecting part and a second connecting part. The first connecting part includes a first connecting post 202 and a boss 201. The boss 201 is integrally fixedly connected to or detachably connected to the side wall of the massage head 1 away from the striking part 1001. The first end of the first connecting post 202 is fixedly or detachably connected to the side wall of the boss 201 away from the massage head 1. The detachable connection can be a bolt connection. The massage head 1, the boss 201, and the first connecting post 202 are all coaxially arranged. The first spiral 4 on the first connecting post 202 is set small so that the first spiral 4 can be regarded as a protrusion 11 relative to the second spiral 5. The second connecting part includes a second connecting post 203, which is disposed at the end of the piston 3 near the massage head 1. The sidewall of the head 1 is recessed inward to form a connecting hole 204, in which a second spiral 5 is formed. The second spiral 5 extends to the end sidewall of the connecting hole 204 near the end of the massage head 1. The protrusion 11 can travel within the second spiral 5. A limiting protrusion 13 that cooperates with the protrusion 11 is provided at the end of the groove of the second spiral 5. The limiting protrusion 13 is provided in two positions: the first position is that the limiting protrusion 13 is spaced apart from the bottom sidewall of the end of the second spiral 5, so that the limiting protrusion 13 and the bottom sidewall of the end of the second spiral 5 form a storage space for the protrusion 11. When the massage head 1 and the piston 3 are connected, the protrusion 11 travels to the end of the second spiral 5 and passes the limiting protrusion 13 and finally sits in the storage space; the second position is that the limiting protrusion 13 is located at the bottom sidewall of the end of the second spiral 5. When the massage head 1 and the piston 3 are connected, the protrusion 11 travels to the end of the second spiral 5 and is located between the limiting protrusion 13 and the side groove wall of the second spiral 5. In this embodiment, the second spiral 5 is a spiral groove 12.

The connecting part 2 also includes a limiting member, which includes an elastic fixing part 205 and an elastic abutment part 206. The elastic fixing part 205 and the elastic abutment part 206 are coaxially arranged. The elastic abutment part 206 is located at the end of the elastic fixing part 205 and the two are integrally formed. Correspondingly, a limiting groove 207 is provided circumferentially at the end of the first connecting post 202 near the boss 201. Both the elastic fixing part 205 and the elastic abutment part 206 are sleeve structures. During installation, the limiting member is sleeved on the outer periphery of the limiting groove 207, which can axially limit the elastic fixing part 205 and the elastic abutment part 206. Preferably, the axial length of the limiting member formed by the elastic fixing part 205 and the elastic abutment part 206 is equal to the axial length of the limiting groove 207, and the length error between the two does not exceed 0.1 cm. Specifically, the outer diameter of the elastic fixing part 205 is not less than the minor diameter of the second spiral 5, and the outer diameter of the elastic abutting part 206 is not less than the diameter of the connecting hole 204. Thus, when the massage head 1 and the piston 3 are connected, the elastic fixing part 205 is located between the outer wall of the limiting groove 207 and the groove of the second spiral 5, and is squeezed, filling the fitting gap between the second spiral 5 and the limiting groove 207. This results in an indirect interference fit between the first connecting post 202 and the connecting hole 204, forming a sealed space in the connecting hole 204 to prevent moisture, dust, and other impurities from entering. At the same time, the friction between the connecting hole 204 and the first connecting post 202 is significantly enhanced. Moreover, at this time, the elastic abutting part 206 is located outside the connecting hole 204 and between the boss 201 and the second connecting post 203, and is squeezed. The top of the elastic fixing part 205 facing the connecting hole 204 can be appropriately designed with a chamfer or rounded corner, and/or the opening of the connecting hole 204 can be flared or chamfered or rounded, making it easier for the elastic fixing part 205 to be inserted into the connecting hole 204.

In this embodiment, the specific connection structure between the connecting rod 7 and the piston 3 is the same as that between the connecting rod 7 and the piston 3 in the massage head assembly in Embodiment 1, and will not be described again. Similarly, the outer wall of the piston 3 is fitted with a shock-absorbing structure 15. In this embodiment, the installation position and specific structure of the shock-absorbing structure 15 are also as described in Embodiment 1.

As another possible implementation, both the first spiral 4 and the second spiral 5 are set as spirals with more than one turn. A limiting protrusion 13 is provided on the inner wall of the end of the first spiral 4 and/or the second spiral 5 away from each other. When the massage head 1 is installed on the piston 3, the corresponding second spiral 5 and/or first spiral 4 are press-fitted against the limiting protrusion 13, thereby further improving the stability of the massage head 1 installation.

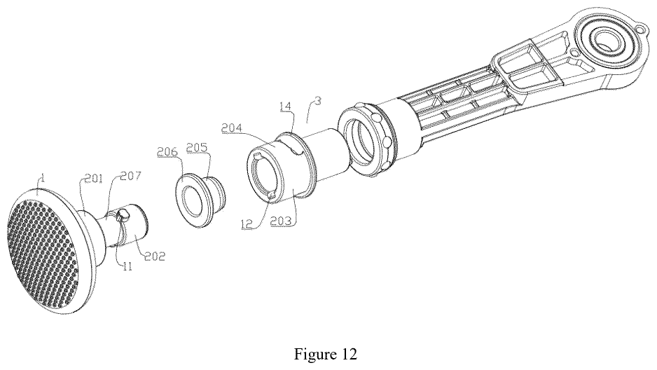

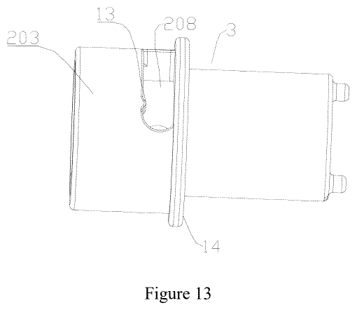

Example 7 As shown in FIGS. 12-13, the difference between this example and Example 6 is that in this example, the outer wall of the end of the second connecting post 203 away from the massage head 1 is provided with an arc-shaped groove 208 that communicates with the end of the second spiral 5 in the connecting hole 204. The limiting protrusion 13 is preferably located at the end of the arc-shaped groove 208. There are two possible positions for the limiting protrusion 13 in the arc-shaped groove 208: the first is that the limiting protrusion 13 is spaced apart from the bottom side wall of the end of the arc-shaped groove 208, thus the limiting protrusion 13 and the arc-shaped groove 208 forms a storage space for the protrusion 11. When the massage head 1 is connected to the piston 3, the protrusion 11 moves to the end within the second spiral 5 and finally enters the arc-shaped groove 208, passing the limiting protrusion 13 and finally settling within the storage space. Alternatively, the limiting protrusion 13 is located on the bottom sidewall of the end of the arc-shaped groove 208. When the massage head 1 is connected to the piston 3, the protrusion 11 moves to the end within the second spiral 5 and finally enters the arc-shaped groove 208, settling between the limiting protrusion 13 and the sidewall of the arc-shaped groove 208, and is fixed by an interference fit.

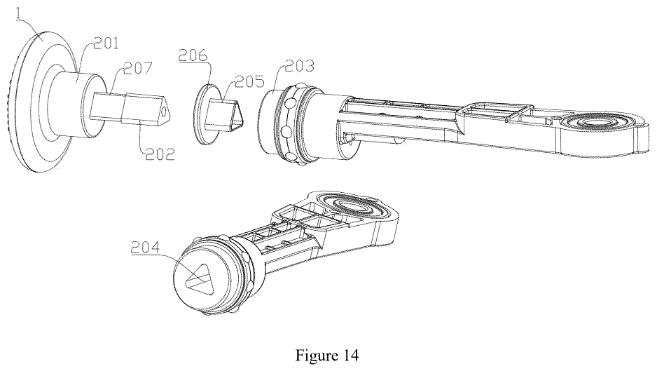

Example 8 As shown in FIGS. 14-17, the massage head assembly in this example includes a massage head 1, a connecting part 2, and a piston 3. The piston is connected to the connecting rod 7 of the fascia gun. The connecting part 2 includes a first connecting part, a second connecting part, and a limiting member. The first connecting part includes a boss 201 and a first connecting post 202, the second connecting part includes a second connecting post 203, and the limiting member includes an elastic fixing part 205 and an elastic abutment part 206. The connection method and structure of each component in this example differ from those in Example 1 only in that the first connecting post 202 does not have a first spiral 4, the connecting hole 204 does not have a second spiral, and the shapes of the first connecting post 202, the limiting groove 207, the elastic fixing part 205, and the connecting hole 204 are different, resulting in different connection relationships. All other aspects are the same, as detailed in Example 1 above. For example, the connection structure of the connecting rod 7 and the piston 3 is the same.

Specifically, the first connecting post 202, the limiting groove 207, the elastic fixing part 205, and the connecting hole 204 all have a mutual cooperation relationship. In Embodiment 1, the first connecting post 202, the limiting groove 207, the elastic fixing part 205, and the connecting hole 204 are all cylindrical. However, in this embodiment, the first connecting post 202, the limiting groove 207, the elastic fixing part 205, and the connecting hole 204 can be set as a prism, a square prism, or a cross prism. The first connecting post 202 and the connecting hole 204 are also directly inserted into the connecting hole 204.

Specifically, when the first connecting post 202, the limiting groove 207, the elastic fixing part 205, and the connecting hole 204 are set as prisms, the prism can be a triangular prism, a square prism, or an octagonal prism, etc., and all sides of the prism are of equal length. As shown in FIG. 14, this embodiment uses a triangular prism as a specific example, where the first connecting post 202, the limiting groove 207, the elastic fixing part 205, and the connecting hole 204 are all configured as triangular prisms. The first connecting post 202 is configured as a triangular prism, and a triangular prism-shaped limiting groove 207 is provided on the outer wall of one end of the first connecting post 202 near the boss 201. The limiting groove 207 is located at the connection between the boss 201 and the first connecting post 202 and has a certain axial width. The elastic fixing part 205 and the elastic abutment part 206 both have triangular prism-shaped inner holes. When stationary, the limiting member is sleeved on the outer periphery of the limiting groove 207, and the limiting groove 207 restricts the limiting member on the first connecting post 202 to prevent the limiting member from falling off. The elastic fixing part 205 is configured as a triangular prism. The external dimensions of the elastic fixing part 205 are not less than the external dimensions of the first connecting post 202 and are larger than the dimensions of the connecting hole 204. Thus, when the piston 3 is connected to the massage head 1, the elastic fixing part 205 can be located between the first connecting post 202 and the connecting hole 204 to form an interference fit. This significantly enhances the surface friction between the first connecting post 202 and the connecting hole 204, which can firmly fix the massage head 1 in the connecting hole 204. More preferably, the top of the elastic fixing part 205 facing the connecting hole 204 can be appropriately designed as a chamfer or rounded corner, and/or the opening of the connecting hole 204 is flared or chamfered or rounded corner, which makes it easier for the elastic fixing part 205 to be inserted into the connecting hole 204. More preferably, the errors between the external dimensions of the elastic fixing part 205 and the external dimensions of the first connecting post 202, and the errors between the external dimensions of the elastic fixing part 205 and the connecting hole 204, are all no more than 0.1 cm. This error setting facilitates the insertion of the elastic fixing part 205 into the connecting hole 204 of the piston 3 and prevents the piston 3 from falling out.

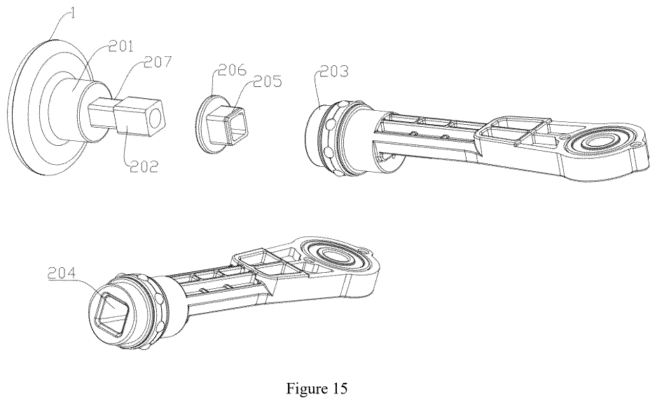

Specifically, as shown in FIG. 15, when the first connecting post 202, the limiting groove 207, the elastic fixing part 205, and the connecting hole 204 are configured as square posts, the four sides of the square post are of equal length. The first connecting post 202 is a square post. A square post-shaped limiting groove 207 is provided on the outer wall of one end of the first connecting post 202 near the boss 201. The limiting groove 207 is located at the connection between the boss 201 and the first connecting post 202 and has a certain axial width. Both the elastic fixing part 205 and the elastic abutment part 206 have square post-shaped inner holes. When stationary, the limiting member is fitted onto the outer periphery of the limiting groove 207, which restricts the limiting member onto the first connecting post 202, preventing it from falling off. The elastic fixing part 205 has a square post-shaped outer shape and its external dimensions are not small. The outer dimension of the first connecting post 202 is larger than the size of the connecting hole 204. Therefore, when the piston 3 is connected to the massage head 1, the elastic fixing part 205 can be positioned between the first connecting post 202 and the connecting hole 204, forming an interference fit. This significantly enhances the surface friction between the first connecting post 202 and the connecting hole 204, firmly fixing the massage head 1 to the piston 3. More preferably, the top of the elastic fixing part 205 facing the connecting hole 204 can be appropriately designed with a chamfer or rounded corner, and/or the opening of the connecting hole 204 is flared or chamfered or rounded, making it easier for the elastic fixing part 205 to be inserted into the connecting hole 204. More preferably, the difference between the outer dimension of the elastic fixing part 205 and the outer dimension of the first connecting post 202, and the difference between the outer dimension of the elastic fixing part 205 and the size of the connecting hole 204, do not exceed 0.1 cm. This difference in size facilitates the insertion of the elastic fixing part 205 into the connecting hole 204 and prevents the first connecting post 202 from falling out.

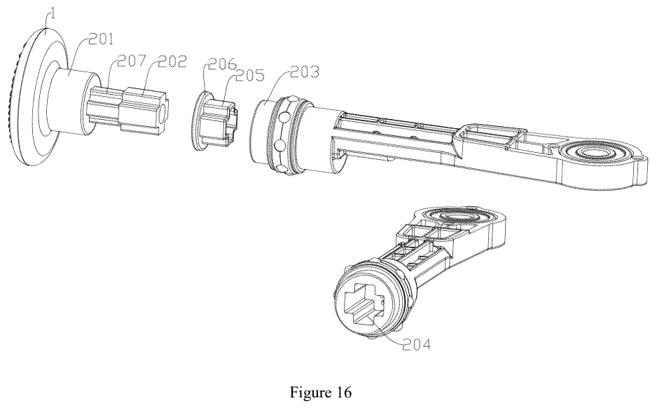

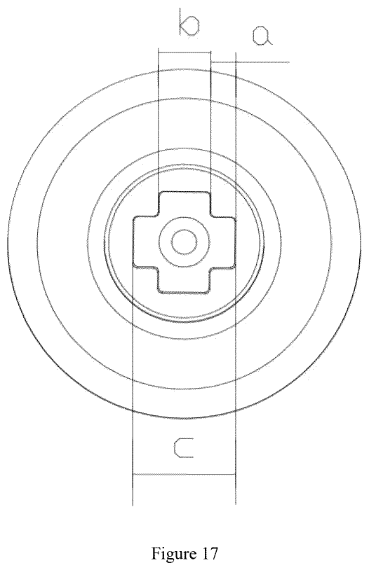

Specifically, as shown in FIGS. 16-17, when the first connecting post 202, the limiting groove 207, the elastic fixing part 205, and the connecting hole 204 are configured as a cross post, as shown in the figure, the length of segment a of the cross post is half the length of segment b, and the length of segment b is half the length of segment c. The first connecting post 202 is configured as a cross post, and a cross-shaped limiting groove 207 is provided on the outer wall of one end of the first connecting post 202 near the boss 201. The limiting groove 207 is located at the connection between the boss 201 and the first connecting post 202 and has a certain axial width. The elastic fixing part 205 and the elastic abutment part 206 both have cross-shaped inner holes. When stationary, the limiting member is sleeved on the outer periphery of the limiting groove 207, and the limiting groove 207 restricts the limiting member on the first connecting post 202 to prevent the limiting member from falling off. The outer shape of the elastic fixing part 205 is configured as a cross post, and the outer dimension of the elastic fixing part 205 is not less than that of the first connecting post 202. The external dimension of the connecting post 202 is larger than the dimension of the connecting hole 204. Therefore, when the piston 3 is connected to the massage head 1, the elastic fixing part 205 can be positioned between the first connecting post 202 and the connecting hole 204, forming an interference fit. This significantly enhances the surface friction between the first connecting post 202 and the connecting hole 204 of the piston 3, firmly fixing the massage head 1 to the piston 3. More preferably, the top of the elastic fixing part 205 facing the connecting hole 204 can be appropriately designed with a chamfer or rounded corner, and/or the opening of the connecting hole 204 is flared or chamfered or rounded, making it easier for the elastic fixing part 205 to be inserted into the connecting hole 204. More preferably, the difference between the external dimension of the elastic fixing part 205 and the external dimension of the first connecting post 202, and the difference between the external dimension of the elastic fixing part 205 and the dimension of the connecting hole 204, are both no more than 0.1 cm. This difference in size facilitates the insertion of the elastic fixing part 205 into the connecting hole 204 of the piston 3 and prevents the piston 3 from falling out.

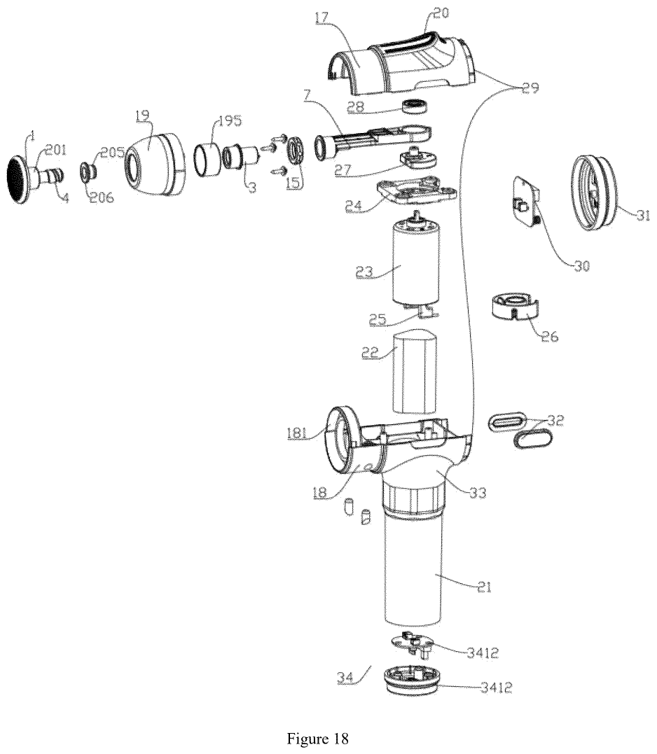

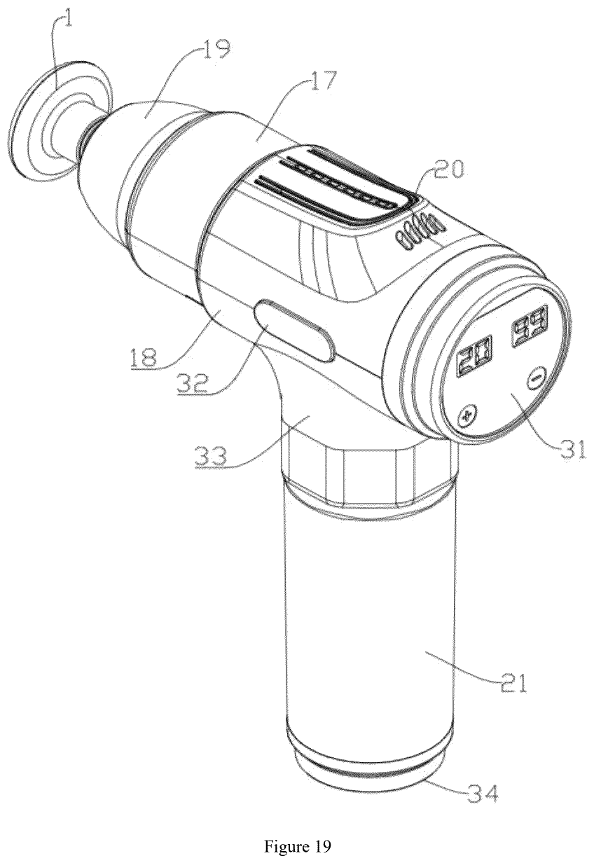

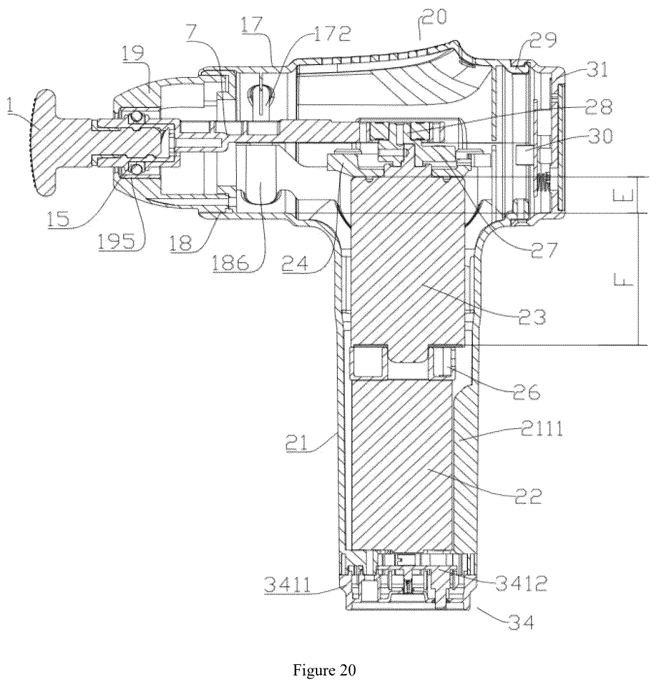

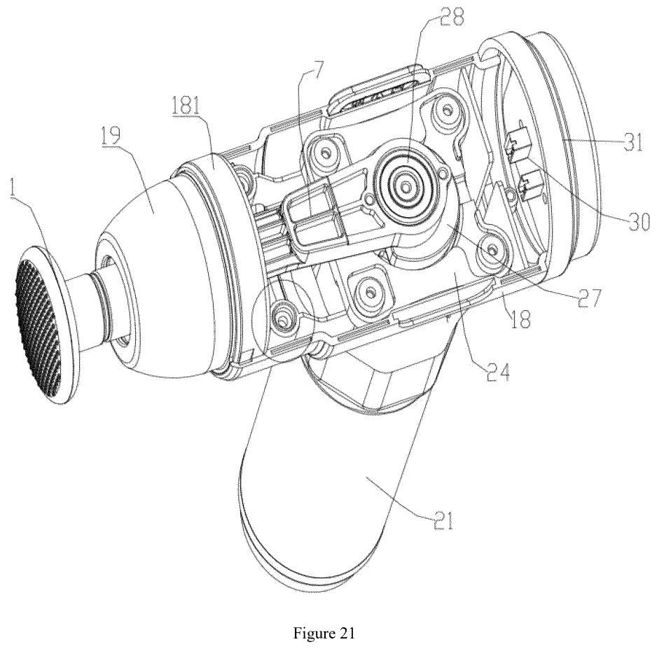

The present invention also discloses a fascia gun, as shown in FIGS. 18-21. The fascia gun includes a main body and the above-mentioned massage head assembly. The main body includes a shell and a battery 22, a motor 23 and a drive mechanism disposed in the shell. The shell includes a head cover 19, a tail cover 31, an upper shell 17, a lower shell 18 and a handle shell 21. The upper shell 17 and the lower shell 18 form a main cavity. The handle shell 21 is integrally connected to the lower side wall of the lower shell 18 and has a handle cavity inside. The main cavity has a first through hole at its front end and a second through hole at its rear end. The head cover 19 has a third through hole, connected to the first through hole, and the third through hole is coaxial with the first through hole. The upper end of the motor 23 is located within the main cavity, and the lower end of the motor 23 is located within the handle cavity. The output end of the motor 23 faces upward and is located within the main cavity, connected to the drive assembly. The massage head assembly includes a massage head 1 and a connecting part 2. The main cavity also contains a piston 3, a shock-absorbing structure 15, and a drive mechanism. The drive mechanism includes a drive assembly and a connecting rod 7. The massage head 1 is located outside the head cover 19. The drive assembly is connected to one end of the connecting rod 7, and the other end of the connecting rod 7 passes through the first through hole and connects to the piston 3 located within the third through hole, performing reciprocating motion.

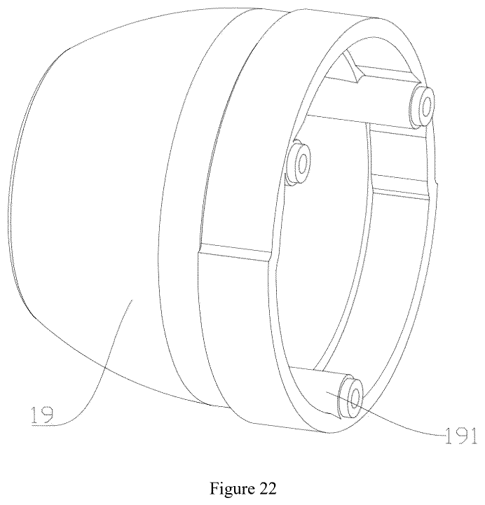

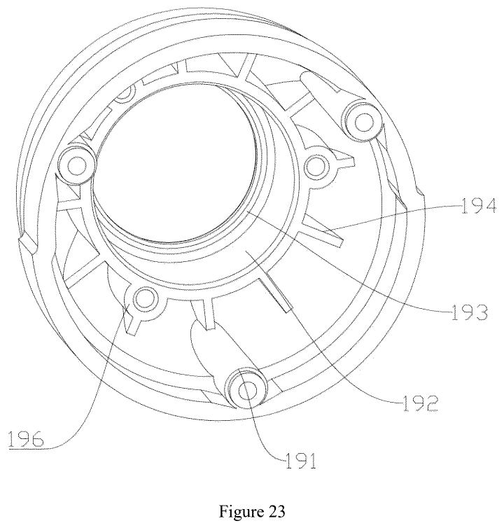

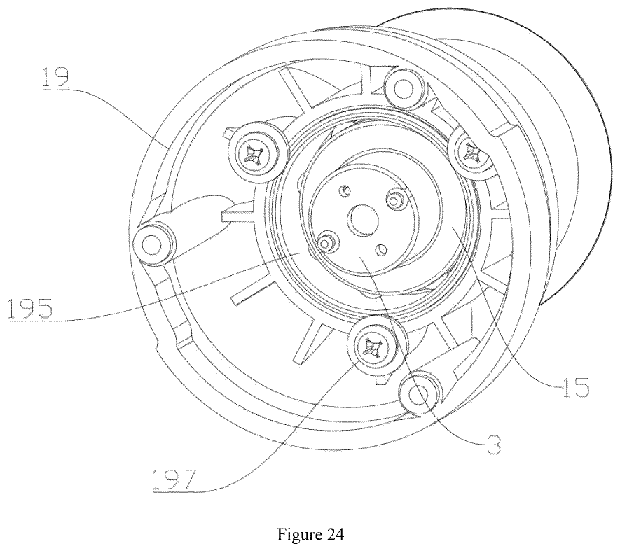

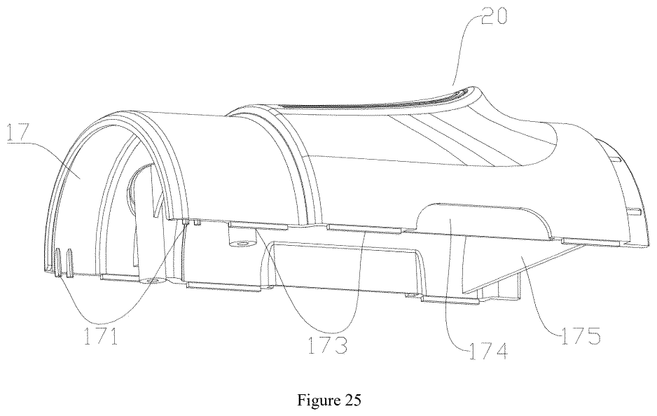

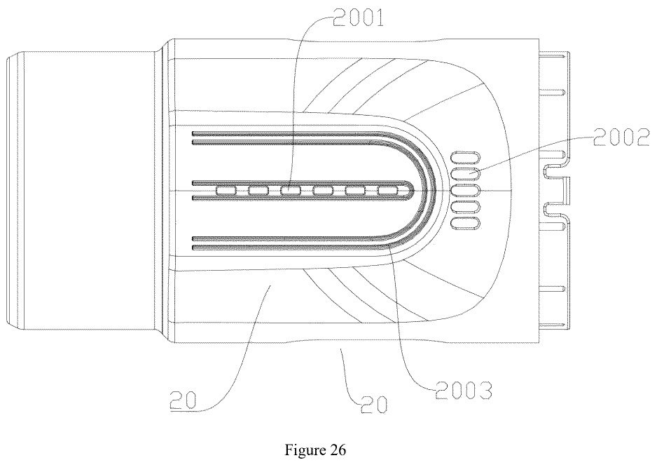

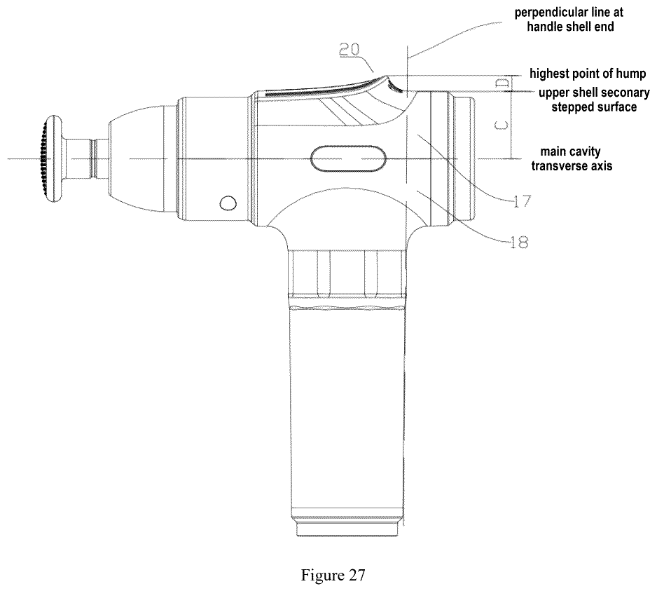

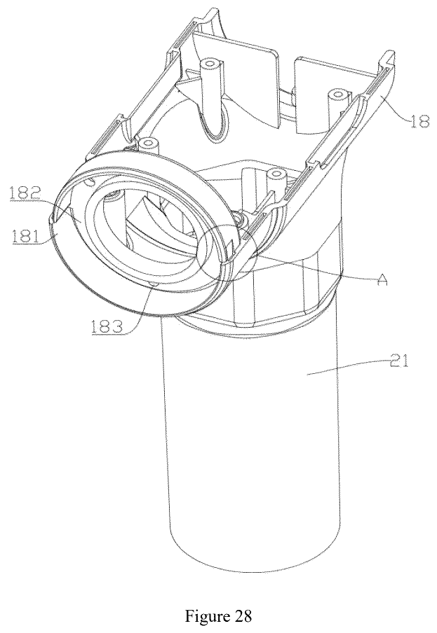

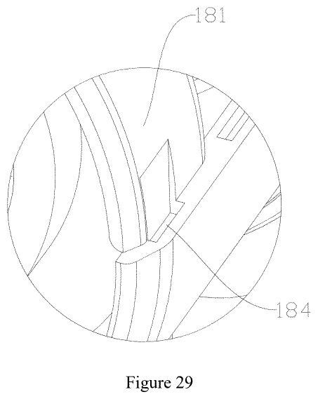

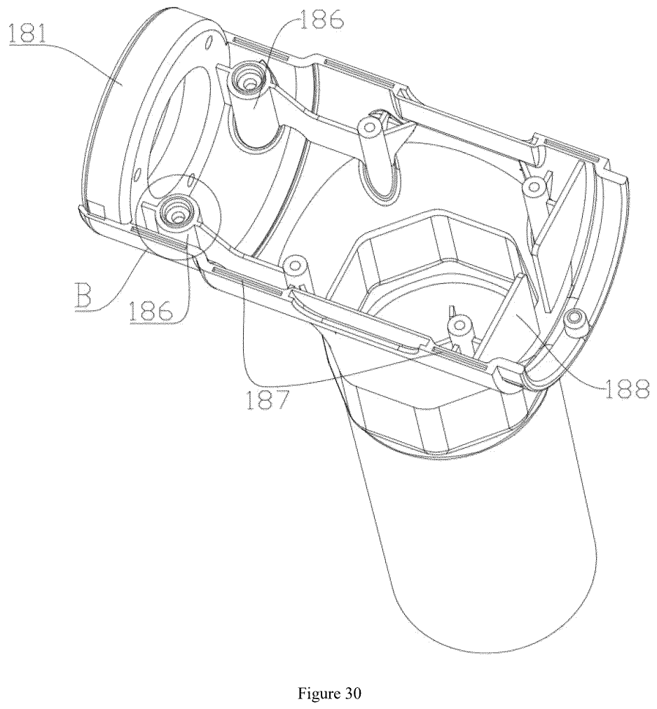

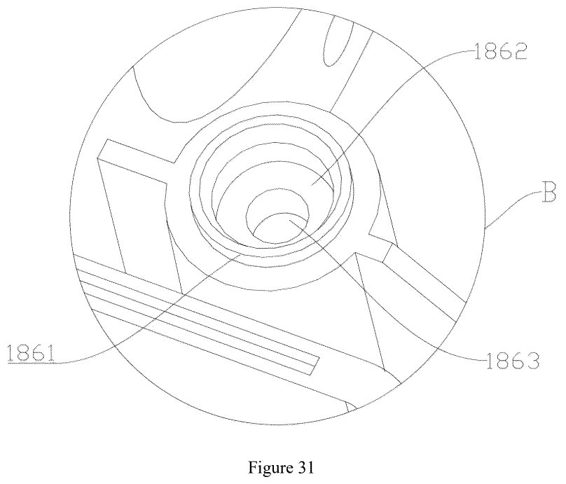

Specifically, as shown in FIGS. 22-31, the head cover 19 has an annular structure. The outer diameter of the front end of the head cover 19 is smaller than the outer diameter of the rear end, and the front end of the head cover 19 transitions to the rear end in an arc shape. A head cover connecting ring 181 is formed at the front end of the lower shell 18, and an annular mounting groove 182 is formed at the front end of the head cover connecting ring 181. At least one head cover connecting hole 183 is provided on the annular mounting groove 182. At least one third connecting post 191 with internal threads is provided on the inner side wall of the rear end of the head cover 19. During connection, the rear end of the head cover 19 is inserted into the annular mounting groove 182 and then fixed by bolts. To facilitate the positioning and installation of the head cover 19, i.e., the alignment of the head cover connecting hole 183 with the threaded hole, the outer diameter of the lower part of the head cover connecting ring 181 is larger than the outer diameter of the upper part, forming two external steps. The inner diameter of the lower part is larger than the inner diameter of the upper part, thus forming two internal steps. The outer diameter of the outer wall of the upper part is smaller than that of the outer wall of the lower part, thus forming two steps. When the tail end of the head cover 19 is installed in the annular mounting groove 182, the two steps formed at the tail end of the head cover 19 correspond to and abut with the two internal steps formed at the upper and lower parts of the head cover connecting ring 181, thereby determining the installation position of the head cover 19. To facilitate the installation of the upper cover, a top cover limiting groove 184 is provided at the steps formed by the upper and lower outer walls of the head cover connecting ring 181. Correspondingly, the inner diameter of the front end of the upper shell 17 is smaller than the inner diameter of the front end of the lower shell 18, but their outer diameters are equal. A corresponding limiting post 171 is provided on the lower side wall of the front end of the upper shell 17, which mates with the top cover limiting groove 184. By inserting the limiting post 171 into the top cover limiting groove 184, the upper shell 17 is fitted onto the upper part of the head cover connecting ring 181, achieving the mating installation of the upper shell 17 and the lower shell 18.

An annular groove 192 is provided on the inner sidewall of the front end of the head cover 19. An annular boss 193 is provided at the front end of the annular groove 192. A radially and circumferentially distributed reinforcing plate 194 is formed between the annular groove 192 and the inner surface of the front end of the head cover 19 to increase the strength of the annular groove 192 and prevent deformation during operation. When the installation is completed, the shock-absorbing structure 15 is located in the annular groove 192. In order to reduce the wear between the shock-absorbing structure 15 in the massage component assembly and the groove wall of the annular groove 192, a wear-resistant ring 195 is provided in the annular groove 192. Part of the reinforcing plate 194 is provided with a fourth connecting post 196 with a threaded hole. In use, the fastener 197 is fixed on the fourth connecting post 196. One side of the wear-resistant ring 195 is fixed by the fastener 197, while the other side of the wear-resistant ring 195 is limited by the annular boss 193. Specifically, the fastener 197 can be a structure such as a large nut screw, and the wear-resistant ring 195 is fixed by the edge of the nut.

It is important to note that during installation, the front side of the wear-resistant ring 195 should first be abutted against the inner surface of the annular boss 193 at the front end of the head cover 19. Then, the wear-resistant ring 195 is fixed in the annular groove 192 using fasteners 197. Next, the rear end of the head cover 19 is aligned with the boss of the head cover connecting ring 181 for initial fixation. Fasteners 197 are then driven into the threaded hole of the third connecting post 191 through the head cover connecting hole 183 inside the body to secure the head cover 19. Finally, the limiting post 171, which has a protruding feature at the bottom front end of the upper housing 17, is inserted into the upper cover limiting groove 184 to achieve a snap-fit connection between the upper housing 17 and the lower housing 18.

Specifically, the lower housing 18 also includes at least one second mounting groove 185 on its outer surface. The second mounting groove 185 has a lower connecting hole 1863 that penetrates the lower housing 18. A lower connecting post 186 extending vertically upwards is provided on the inner surface of the lower housing 18 corresponding to the lower connecting hole 1863, and the lower connecting hole 1863 extends through the lower connecting post 186. A connecting groove 1862 coaxial with the lower connecting hole 1863 is provided on the end sidewall of the lower connecting post 1862. The end sidewall of the connecting groove 1862 extends outwards to form a mounting wall 1861, and the inner diameter of the mounting wall 1861 gradually increases from the inside to the outside, forming a tapered hole. Correspondingly, the upper housing 17 extends vertically downwards from its inner surface to form an upper connecting post 172 with an upper connecting hole. The outer diameter of the upper connecting post 172 is slightly smaller than the inner diameter of the connecting groove 1862, allowing the end of the upper connecting post 172 to embed into the connecting groove 1862 and abut against the bottom wall of the connecting groove 1862 during installation. The upper connecting hole is a screw hole. When connecting the upper housing 17 and the lower housing 18, bolts are inserted from the second mounting groove 185 of the lower housing 18 into the lower connecting hole 1863 and then into the upper connecting hole, thereby connecting the upper housing 17 and the lower housing 18 together. After the upper housing 17 and the lower housing 18 are connected, the second mounting groove 185 can be sealed with a sealing plug, providing waterproofing, dustproofing, and protection. Furthermore, for better connection, the sum of the lengths of the upper connecting post 172 and the lower connecting post 186 should be appropriate, ensuring a perfect fit between the housings during connection and achieving limiting and pre-fixing during installation.

Furthermore, the upper housing 17 has a continuous or segmented sealing edge 173 at the connection with the lower housing 18, and the lower housing 18 has a sealing groove 187 corresponding to the sealing edge 173 at the connection with the upper housing 17. In other embodiments, the upper housing 17 has a continuous or segmented sealing groove 187 at the connection with the lower housing 18, and the lower housing 18 has a sealing edge 173 corresponding to the sealing groove 187 at the connection with the upper housing 17. When the two housing parts are installed, the sealing edge 173 can be embedded into the sealing groove 187 of the other housing, thereby achieving a seal. These two structures also enable pre-positioning and pre-fixing before screw fixing. In other embodiments, the sealing groove 187 and the sealing edge 173 can also be stepped to further increase the sealing performance.

The upper housing 17 protrudes above the motor 23 to form a hump 20. The entire hump 20 is located in front of the vertical line at the end of the handle housing 21. In the side view of this fascia gun, the upper housing of the entire fascia gun has three steps: the zero step at the head cover 19, the second step where the hump 20 is located, and the first step at the upper surface of the upper housing 17 between the head cover 19 and the hump 20. The diameter of the housing increases progressively from the zero step, the first step, and the second step. The hump 20 extends from the connection between the first step and the second step towards the tail end of the fascia gun, forming a peak in the middle. Specifically, the side of the peak facing the front end of the fascia gun is the front slope, and the other side is the rear slope. The slope of the front slope is slightly gentler than that of the rear slope, and the entire hump 20 is located in front of the vertical line at the end of the handle housing 21. The connection between the front slope and the rear slope is arc-shaped. The front slope of the hump 20 has multiple transverse heat dissipation holes 2001 sequentially formed along the projection line of the main cavity's transverse axis on the front slope. To prevent deformation of the transverse heat dissipation holes 2001 during use, several semi-annular grooves 2003 are provided on the outer periphery of the transverse heat dissipation holes 2001, thereby increasing their service life. Furthermore, the rear slope has multiple longitudinal heat dissipation holes 2002 formed along the projection line perpendicular to the main cavity's transverse axis on the rear slope. The longitudinal heat dissipation holes are symmetrically arranged with the main cavity's transverse axis as the central axis. The transverse heat dissipation holes 2001 and longitudinal heat dissipation holes 2002 constitute a heat dissipation structure. In this fascia gun, the distance from the outer surface of the upper shell 17 to the main cavity's transverse axis is C, where C is 4.32 times D. During operation, the fascia gun generates a large amount of heat within the main cavity, causing hot air to rise. The shape and height of the hump 20 facilitate the accumulation of hot air, and the heat dissipation holes formed according to the above method have higher heat dissipation efficiency.

Specifically, the handle housing 21 has a handle cavity, and the battery 22 is entirely located within the handle cavity, specifically at its lower part. The inner surface of the handle cavity has multiple fixing plates 2111 extending towards the battery 22. In this embodiment, the battery 22, viewed from the bottom, is a triangular battery pack with rounded corners on three sides, formed by binding three batteries together. There are three fixing plates 2111, each abutting near the midline of one of the three sides of the battery 22. A battery support base 2112 is provided between every two adjacent fixing plates 2111. The three battery support bases 2112 abut against the three rounded corners of the bottom of the battery 22. The bottom of each fixing plate 2111 is not lower than the plane of the support base and not higher than the plane of the lower surface of the motor 23.

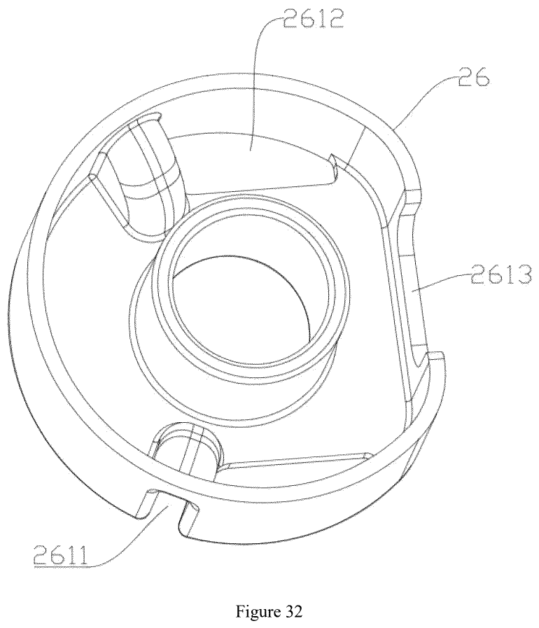

Specifically, the lower part of the motor 23 is located inside the handle cavity and above the battery 22, while the upper part is located inside the main cavity. A motor fixing plate 24 for fixing the upper end of the motor 23 is provided within the main cavity. The motor fixing plate 24 has fixing holes, and a fixing post extends upward from the bottom side wall of the lower housing 18. The fixing holes of the motor fixing plate 24 are fitted onto the fixing post. The upper end of the battery 22 is fixed to the motor fixing plate 24 with bolts. In this embodiment, the distance from the mounting plane of the motor 23 (the plane where the motor fixing plate 24 is located) to the lower surface of the main cavity is E, and the distance from the lower surface of the motor 23 to the upper surface of the handle cavity is F. It can be seen that the ratio of the portion of the motor 23 extending beyond the handle cavity to the portion located within the handle cavity is approximately 1/4, i.e., the ratio of E to F is approximately 1/4. Preferably, during installation, the center lines of the battery 22 and the motor 23 are collinear, which helps reduce vibration during fascia gun operation. Furthermore, since the lower end face of the motor 23 has output wires, which have contacts and are prone to detachment, an L-shaped insulating sleeve 25 is provided on the lower end face of the battery 22 to protect it and provide insulation. To improve the stability of the battery 22, a shock absorber 26 is provided in the gap between the battery 22 and the motor 23, as shown in FIG. 32. The shock absorber 26 has a hollow interior with a through hole at its center. A ring of raised edges surrounds the through hole to enhance its stability. The through hole allows the protrusion at the bottom of the motor 23 to pass through. The bottom edge of the shock absorber 26 is recessed inward to form a relief groove 2611, which allows space for the fixing plate 2111 that secures the battery 22, preventing collisions between the fixing plate 2111 and the bottom of the shock absorber 26 during use. Furthermore, to facilitate the accommodation of the insulating sleeve 25, a through-hole accommodating groove 2612 is provided inside the shock absorber 26 to accommodate the insulating sleeve 25. The outer raised edge of the shock absorber 26 has a notch, which serves as a wire groove 2613, facilitating wire passage and resulting in neater wiring. In another embodiment, the shock absorber 26 can be made of sponge.

Specifically, the drive assembly includes an eccentric wheel 27. The upper surface of the motor mounting plate 24 has a drive groove 2411 for mounting the eccentric wheel 27. The output shaft of the motor 23 passes through the motor mounting plate 24 and connects to the eccentric wheel 27 within the drive groove 2411. The end of the connecting rod 7 in the massage head assembly furthest from the massage head 1 has a drive hole, and a bearing 28 is installed within the drive hole. The bearing 28 connects to the output shaft at the upper end of the eccentric wheel 27, thus forming a complete transmission system. The motor 23 drives the eccentric wheel 27, which in turn drives the connecting rod 7 via the bearing 28. The connecting rod 7 then drives the piston 3 to slide within the annular groove 192. Simultaneously, the shock-absorbing structure 15 provides corresponding shock absorption.

An annular flange 29 extends from the tail end formed by the upper housing 17 and the lower housing 18. The tail cover 31 is sleeved on the outside of the annular flange 29, and a tail cover connecting post with a threaded hole is provided on the inner side wall of the annular flange 29. Correspondingly, a tail cover connecting hole is provided on the outer side wall of the tail cover 31, which is provided with a tail cover connecting hole corresponding to the threaded hole in the tail cover connecting post. The tail cover 31 is connected to the annular flange 29 by bolts. Furthermore, an upper baffle 175 extends inward from the inner side wall of the tail end of the upper housing 17, and a lower baffle 188 extends inward from the inner side wall of the tail end of the lower housing 18. The baffles formed by the upper baffle 175 and the lower baffle 188 can separate the two cavities, preventing external debris or wires from entering the cavity where the transmission structure is located, thus preventing malfunctions. After the upper housing 17 and the lower housing 18 are connected, a baffle is formed between the upper baffle 175 and the lower baffle 188, and a wire hole is provided. A display control board 30 is installed in the space between the baffle and the tail cover 31. The wire hole facilitates the electrical connection between the display control board 30 and components such as the battery 22 inside the main body, and the baffle restricts the display control board 30 to be located inside the tail cover 31.

Furthermore, a display plate 32 is provided on the outer casing. The display plate 32 can be a logo plate or an electronic display screen, used to display parameters such as temperature and rotation speed, allowing the user to understand the usage status. Specifically, a display structure mounting groove 174 is provided at the junction of the upper housing 17 and the lower housing 18. The display structure mounting groove 174 is located directly above the handle housing 21. The upper wall of the display structure mounting groove 174 has axially distributed mounting protrusions, forming a groove for mounting the display plate between the mounting protrusions and the bottom wall of the display structure mounting groove 174. Correspondingly, the display plate 32 also has a corresponding protrusion. During installation, it is only necessary to align the display plate 32 with the handle housing 21. The corresponding protruding edge engages with the groove. Since the display structure mounting groove 174 is composed of an upper housing 17 and a lower housing 18, with half of the groove located on the lower housing 18 and half on the upper housing 17, the display plate 32 is first installed in the display structure mounting groove 174 of the lower housing 18, and then the upper housing 17 is installed. This allows the protruding edge of the display plate 32 to engage with the groove. For improved stability, a sealing ring can be placed at the connection between the display plate 32 and the display structure mounting groove 174 to enhance the seal. It can also be fixed using adhesive, snap-fit, or other methods to further ensure a tight seal.

The connection between the lower housing 18 and the handle housing 21 of the fascia gun is designed as an arc-shaped structure 33. This reduces the residue of dirt on the external housing, increases aesthetics, and improves grip. Below the arc-shaped structure 33, there is a polygonal area with a polygonal protrusion. The ends of the protrusions are chamfered or rounded to increase safety and improve grip. Preferably, the arc-shaped structure 33 is made of a sweat-absorbing and shock-absorbing material. The space inside the arc-shaped structure 33 can accommodate part of the motor 23.

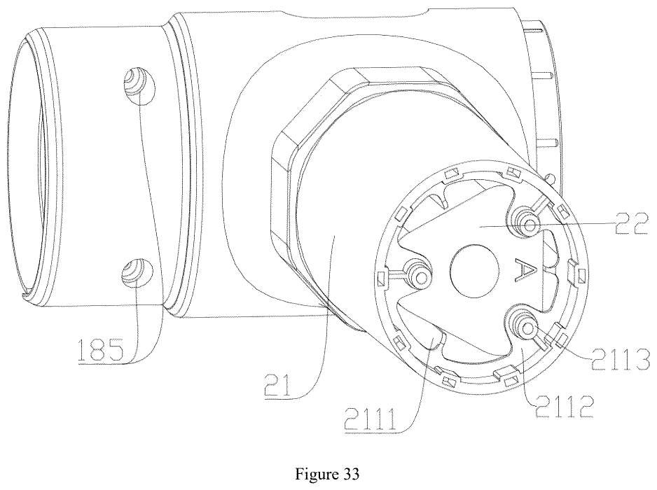

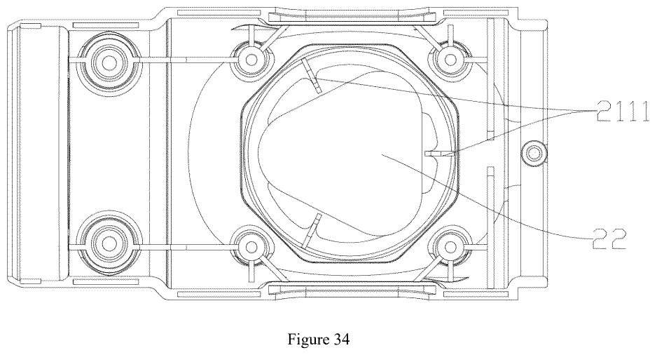

Specifically, as shown in FIGS. 33-34, a bottom cover structure 34 is provided at the bottom of the handle shell 21. The bottom cover structure 34 includes a charging cover 3411 and a charging plate 3412. The battery 22 is entirely located inside the handle shell 21. The charging plate 3412 and the charging cover 3411 are located at the bottom of the handle shell 21. The bottom of the handle shell 21 of the lower housing 18 has a charging plate mounting groove. This charging plate mounting groove has a charging plate mounting post 2113. The charging plate mounting post 2113 is located behind the battery support base 2112. The top of the charging plate mounting post 2113 has a third mounting hole. The outer surface of the top of the third mounting hole also has a step, which abuts against the charging plate 3412. The charging plate 3412 is electrically connected to the battery 22, the display control board 30, and the motor 23. The charging plate 3412 also has a charging port and a main switch, and protrudes outward. Furthermore, the charging plate 3412 has a mounting through hole corresponding to the charging plate mounting post 2113. This through hole allows the charging plate 3412 to extend into the charging plate mounting post 2113 and abut against the step of the charging plate mounting post 2113. The outer and inner diameters of the charging cover 3411 are the same as those of the handle shell 21, and it has through holes corresponding to the charging port and main switch to accommodate the component. The charging cover 3411 should also have mounting through holes corresponding to the charging plate mounting post 2113. During installation, fasteners 197 are passed through the mounting through holes of the charging cover 3411, the charging plate 3412, and the third mounting hole to secure the structure. Preferably, a stepped structure can be provided at the joint between the handle shell 21 and/or the charging cover 3411 near each other to enhance sealing and waterproofing.

The above embodiments are merely preferred embodiments of the present invention and should not be construed as limiting the scope of protection of the present invention. Any non-substantial changes and substitutions made by those skilled in the art based on the present invention shall fall within the scope of protection claimed by the present invention.

1. A massage head assembly for a fascia gun, comprising: a massage head, a connection coupling, and a piston connected to a driving mechanism inside the fascia gun;
wherein the connection coupling comprises a first connection part and a second connection part, wherein the second connection part is formed with a connection hole for the first connection part to enter, the first connection part is fixed to the piston, the second connection part is fixed to the massage head, the first connection part is provided with a first thread, the connection hole is provided with a second thread cooperating with the first thread, wherein the massage head is detachably and rotatably connected to the piston through the second thread and the first thread.

2. The massage head assembly according to claim 1, further comprising a limiting member, wherein the limiting member comprises an elastic fixing part;
wherein the elastic fixing part is arranged between the first connection part and the connection hole, so that the first connection part is in an interference fit with the connection hole and/or the second thread.

3. The massage head assembly according to claim 1, wherein the first connection part comprises a connection column and a boss; wherein the first thread is arranged on the connection column;
wherein, when the massage head and the piston are connected, the connection column is located in the connection hole, and the boss is located outside the connection hole and abuts against an end of the second connection part.

4. The massage head assembly according to claim 3, further comprising a limiting member, wherein the limiting member comprises an elastic abutting part, and wherein the elastic abutting part is sleeved on an outer peripheral side of the first connection part to fill a gap between the boss and the second connection part.

5. The massage head assembly according to claim 2, wherein the first connection part is provided with a limiting groove in a circumferential direction, the elastic fixing part is sleeved in the limiting groove, and an outer diameter of the elastic fixing part is not less than a minor diameter of the second thread; or
wherein the elastic fixing part is embedded in the connection hole, and an inner diameter of the elastic fixing part is not greater than a major diameter of the first thread.

6. The massage head assembly according to claim 1, wherein the driving mechanism inside the fascia gun comprises a connecting rod, the first connection part is arranged on the massage head, the second connection part is arranged on the piston, and one end of the connecting rod facing the piston is provided with a first mounting groove, wherein the connection hole extends through the piston, and an end of the piston away from the massage head is provided with a blocking plate, wherein the blocking plate is configured for closing the connection hole, and wherein one end of the piston away from the massage head is installed in the first mounting groove;
wherein a first vent hole is provided at a bottom of the blocking plate, a second vent hole is provided in the first mounting groove, and the connection hole communicates with the outside through the first vent hole and the second vent hole.

7. The massage head assembly according to claim 1, wherein a limiting protrusion is arranged inside the second thread at an end away from the first connection part, and when the first connection part and the second connection part are installed, the first thread abuts against the limiting protrusion in an interference fit.

8. The massage head assembly according to claim 1, wherein the first thread is set as a convex block, a circular arc groove is arranged in the connection hole, the circular arc groove communicates with the second thread, a limiting protrusion is arranged in the circular arc groove, and when the first connection part and the second connection part are installed, the convex block abuts against the limiting protrusion in an interference fit, or the convex block is restricted between the limiting protrusion and a side wall of the circular arc groove.

9. A fascia gun, comprising a main body and the massage head assembly according to claim 1, wherein the main body comprises a main housing, a battery, a motor and a driving assembly, wherein the battery and the motor are arranged in the main housing and electrically connected to each other, and an output shaft of the motor is connected to one end of a connecting rod in the massage head assembly away from the massage head through the driving assembly.

10. The fascia gun according to claim 9, wherein the main housing comprises a head cover, an upper housing, a lower housing, a tail cover and a handle housing, wherein the lower housing is arranged above the handle housing, the upper housing and the lower housing are connected to form a main cavity, through holes are formed at a front end and a rear end of the main cavity, the head cover is connected to the through hole at the front end of the main cavity, and the tail cover is arranged at the through hole at the rear end of the main cavity; wherein the upper housing is convexly shaped to form a hump directly above the motor, wherein the hump comprises a front slope and a rear slope, the front slope is sequentially formed with a plurality of transverse heat dissipation holes for heat dissipation along a projection line of the transverse axis of the main cavity on the front slope, and the rear slope is provided with a plurality of longitudinal heat dissipation holes for heat dissipation in a direction of a projection line on the rear slope perpendicular to the transverse axis of the main cavity.
